(19) United States
(12) Patent Application Publication
(10) Pub. No.: US 2023/0120206 A1
(43) Pub. Date: Apr. 20, 2023

(54) ENRICHMENT PIPELINE FOR MACHINE LEARNING

(71) Applicant: Steady Platform LLC, Atlanta, GA (US)

(72) Inventors: Amanda Miguel, Atlanta, GA (US); Thaddeus Gholston, Atlanta, GA (US); Jason Robinson, Atlanta, GA (US); Winn Martin, Atlanta, GA (US)

(21) Appl. No.: 17/968,855

(22) Filed: Oct. 19, 2022

Related U.S. Application Data
(60) Provisional application No. 63/257,613, filed on Oct. 20, 2021.

(51) Int. Cl. G06Q 10/10; G06F 16/903

(52) U.S. Cl. CPC G06Q 10/1053; G06F 16/90335

(57) ABSTRACT

Provided are systems and methods for recommending job opportunities via a machine learning engine which is coupled to an enrichment pipeline. The enrichment pipeline can add skills information and other beneficial data to enrich a job profile of a user and use the enriched record to predict an optimal job opportunity or set of opportunities. In one example, the method includes receiving a description of employment data, identifying a unique identifier of a job profile based on the description of the employment data, querying a database with the unique identifier to retrieve a list of skills from the database and that are mapped to the unique identifier, transforming the list of skills from into a skills vector, determining one or more optimal job opportunities via execution of a ML model on the skills vector, and outputting information about the optimal job opportunities via a user interface.

### CROSS-REFERENCE TO RELATED APPLICATION

The present application claims the benefit under 35 USC § 119 of U.S. Provisional Patent Application No. 63/257,613, filed on Oct. 20, 2021, in the United States Patent and Trademark Office, the entire disclosure of which is incorporated herein by reference for all purposes.

### BACKGROUND

Choosing jobs and building a career is a common challenge for the broader population and an integral part of working life. However, finding and applying for the right next job at any given point in a career journey is a nebulous process for many. Job posting data lacks a common, unified structure and presentation methodology that is made broadly available to job seekers. Unfortunately, this lack of a common structure, as well as the propensity for job postings to use various ways to ask for the same requirements or preferred qualifications, makes it hard for a job seeker to know if their specific background, training, education, certifications, qualifications, and the like are a good fit for any particular job.

Furthermore, it's generally challenging for a job seeker to take the next step to understand how their particular skills, which may be evidenced by their specific background, training, education, certifications, qualifications, and the like, might be a good fit for a given job requisition, especially when considering lateral moves into adjacent roles and/or moves into roles that allow job seekers to make career transitions that could leverage their particular skill sets. In these cases, among others, both the job seeker and the potential employer lose the opportunities afforded by the employer's ability to consider a broader pool of applicants for any particular job posting and the potential employee's knowledge of jobs for which they may be a good fit. The example embodiments are directed toward a platform that can ingest, parse, and augment job postings, while making recommendations to end users for what jobs to consider.

Additionally, employment data such as payroll data, scheduling data, location of employment, activities performed, and the like, can be stored at many different data sources such as a payroll provider, a human resources department, a user's mobile device, and the like.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIGS. 1A and 1B are diagrams illustrating an enrichment pipeline coupled to a recommendation engine in accordance with example embodiments.

FIG. 2 is a diagram illustrating a process of enriching a data record with job text in accordance with an example embodiment.

FIG. 3A is a diagram illustrating a process of enriching a data record with skills data in accordance with an example embodiment.

FIG. 3B is a diagram illustrating a data record that is created by the process of ingesting data shown in FIG. 1A, in accordance with an example embodiment.

FIG. 3C is a diagram illustrating examples of a skills vector in accordance with example embodiments.

FIG. 4 is a diagram illustrating a process of enriching a data record with earnings data in accordance with an example embodiment.

FIG. 5 is a diagram illustrating a machine learning model that may be used to predict optimal job opportunities in accordance with an example embodiment.

FIG. 6 is a diagram illustrating a method of enriching a data record and predicting an optimal opportunity for a user based on the enriched data record according to example embodiments.

FIG. 7 is a diagram illustrating a computing system for use in the example embodiments described herein.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, details are set forth to provide a thorough understanding of various example embodiments. It should be appreciated that modifications to the embodiments will be readily apparent to those skilled in the art, and generic principles defined herein may be applied to other embodiments and applications without departing from the spirit and scope of the disclosure. Moreover, in the following description, numerous details are set forth as an explanation. However, one of ordinary skill in the art should understand that embodiments may be practiced without the use of these specific details. In other instances, well-known structures and processes are not shown or described so as not to obscure the description with unnecessary detail. Thus, the present disclosure is not intended to be limited to the embodiments shown, but is to be accorded the widest scope consistent with the principles and features disclosed herein.

For people who are searching, finding employment can be a disjointed experience that will continue to worsen with the rapidly changing nature of work and technology. With differing information and priorities spanning across multiple organizations and people, there exists a tremendous amount of friction for the applicant to identify opportunities that fit specifically to their circumstances. In order to provide users with the type of jobs they are looking for, an opportunity processing pipeline for new job postings is necessary as part of or as an input to a job recommendation engine, service, or the like. Two key challenges must be addressed with such a pipeline. First, it must be robust and flexible enough to manage the high-volume of available jobs data being passed through on a daily basis. Second, the variability of information within a job posting data necessitates standardization and categorization, with associated informational and other metadata augmentation, as needed. Additionally, given limited resources and the variability of available fields in any given job posting, it is often necessary to process a limited number of data records and abstract or aggregate data points up to the larger data sets. These transformations are important not only in how the job postings are served to the consumer, but also ultimately dictate the development and deployment of downstream machine learning (ML) products, which may incorporate natural language processing (NLP) and/or various other ML methodologies, for example for the purposes of recommending specific jobs to particular individuals or groups.

The example embodiments are directed to a recommendation engine that includes machine learning models therein. The recommendation engine is coupled to an enrichment pipeline which ingests job-related data such as listings of opportunities (jobs) on websites, opportunities from jobs feeds, and the like. The data can then be enriched with additional data that is added to the records based on content within the records. The enriched data may include both structured data that is highly organized (e.g., via a predefined data model, etc.), such as payroll data and bank account data, which may have been preprocessed and/or aggregated, and unstructured data such as job descriptions, which are not necessarily formatted according to a predefined data model. Moreover, the pipeline could ingest and process payroll and bank account data, as well as user profile data, although that could be processed beforehand, separately or in combination and/or aggregate. The ingested data may be parsed and transformed into a predefined and standardized data structures (e.g., vectors, etc.) that are understandable to a computer processor and that can be fed into machine learning algorithms/software. Examples of ingesting data and converting the ingested data into a standardized format are described in U.S. Pat. No. 11,100,143, issued on Aug. 24, 2021, which is fully incorporated herein by reference in its entirety for all purposes. Furthermore, the ingested/standardized data may be enriched with additional attributes that the host platform determines are related to the data from internal and/or external services, etc. The enriched data can be added to the parsed data to create a larger record with detailed attributes of a user enabling the machine learning system to make more accurate predictions than if the enrichment process had not occurred.

The enrichment of the data may include adding skills to a user's job profile based on the Occupational Information Network (“O*NET”) system, which is an online database that contains occupational definitions including predefined codes assigned to different job titles and predefined fields/attributes assigned to each job title. At present, there are around 1,000 predefined job titles in the O*NET database along with characteristics/attributes of each. The O*NET database is continually updated with occupation information (e.g., on a quarterly basis, etc.). The example embodiments may rely on O*NET job codes that are assigned to different occupations and use these job codes as a way to standardize the data, although other standardization taxonomies or methodologies could be employed. For example, an ingested job listing may be mapped to a predefined O*NET job code. This mapping may then be used to query additional web-based services for additional information (e.g., via API calls, etc.). The queried/returned data can be added to the ingested job listing, either in individual or aggregated form, to thereby enhance the job listing with additional data that can be processed by analytical and/or machine learning models and used to provide more accurate predictions. It's important to note that the enrichment of a user's job profile could happen in a way that is coupled to the opportunity enrichment pipeline, or more commonly in another pipeline, dynamically when making predictions, aggregations, and/or recommendations, or otherwise separated from job/opportunity processing.

The ingestion pipeline may also include or be connected to a machine learning service that includes one or more machine learning models for identifying information from the ingested employment data. For example, the machine learning models may identify optimal job opportunities for a user based on other opportunities that are performed by or otherwise linked to other users in the community using the data that has been ingested and/or additional machine learning models that infer or predict opportunities for broader user bases. The optimal job opportunity information may be output to the user via a mobile application, website, or the like. Information about the optimal job opportunities, including job titles, scheduling, average pay earned by others working such job opportunities, and the like, can be output through a visualization that is provided to the user.

In the following description, “opportunities” refer to job market postings such as those that may be provided by third party supply partners. The jobs are what is currently available in the market and are representative of the market as a whole. A “job profile” is an aggregated entity across location and employer at the job title level, and it should be noted that a “job profile” is distinct from but may be related to a “user job profile”. In the pipeline, this unit is the basis for standardization, categorization, and enrichment processes. This unit is also used for downstream ML products and income analytics. A job opportunity that has been parsed refers to a process of parsing (e.g., via a software parser, etc.) a job description into relevant data attributes (e.g., job title, skills, work experience, wages, skills, etc.). In addition, “skills” refer to the tasks, abilities, or proficiencies that are listed as either required or preferred in a job description.

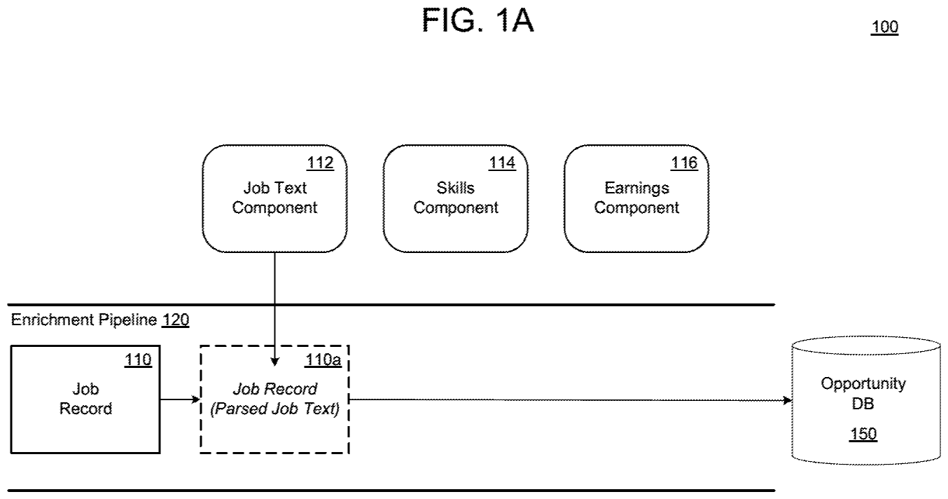

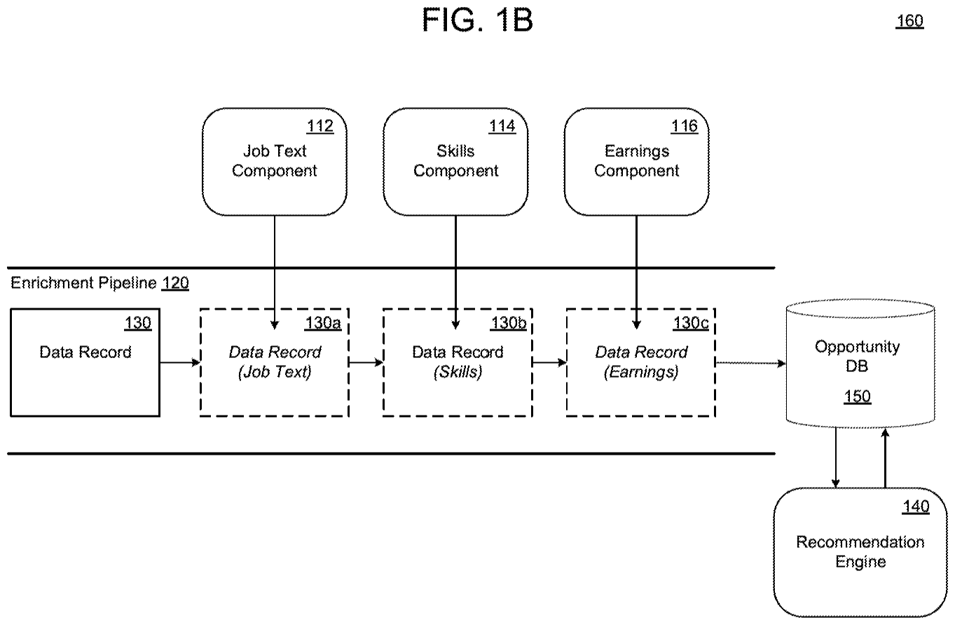

FIG. 1A illustrates a computing environment that performs an enrichment process 100 for a job opportunity such as a job posting online. The job opportunity may be stored within a job record 110 in accordance with an example embodiment. In this example, the enrichment process 100 is performed via an enrichment pipeline 120 coupled to a recommendation engine 140 (shown in FIG. 1B). The recommendation engine 140 may include one or more machine learning models that can predict job opportunities that will be of interest to a particular user based on attributes of the user. The attributes of the user may be collected from the user themselves, for example, in the form of a survey or other questionnaire. As another example, the user may upload a resume, cover letter, unstructured description, etc. It's important to note that various embodiments could place the recommendation engine 140 within the enrichment pipeline 120 or separate from the enrichment pipeline 120, or it could even use more than one of each component, as required.

In order for the recommendation engine 140 to make recommendations on optimal job opportunities, the recommendation engine 140 must be trained to identify jobs. In the example embodiments, job opportunities such as those submitted by third-party partners, can be “standardized” to create a standard profile that can be used for processing by the machine learning system described herein. The standardized job profiles can be stored in an opportunity DB 150 that can be accessed by the recommendation engine 140. In some embodiments, the opportunity DB 150 may be located at the terminus of the enrichment pipeline 120, or it could be accessed via the recommendation engine 140 in the case where enrichment pipeline 120 is directly coupled with the recommendation engine 140, or various other configurations that would be obvious to one skilled in the art.

Referring now to FIG. 1A, a job record 110 represents a data record that could be provided by or otherwise sourced from a third party such as an employer that is seeking employees for a potential job opportunity. The job record 110 may include a description that may include free form text such as a block of text describing the opportunity. Because it is unstructured, the data requires a standardization for downstream processing and aggregation. For these processes, the host platform (not shown), which hosts the enrichment pipeline 120, may perform standard text cleaning processes, regex-based and/or other standardization rules, text-based ML classification modeling, natural language processing, and the like, via a job text component 112, to generate an enriched job record 110a (enriched data record) and store it within the opportunity DB 150. The records stored in the opportunity DB 150 can be used during training of the machine learning model(s) within the recommendation engine 140.

Referring now to FIG. 1B, illustrated is a process 160 of enriching a user's profile with additional attributes, including skills that can be used by the machine learning model when predicting an optimal job opportunity for the user. Here, the user's profile may be a social media profile, a resume, a survey that is filled out by the user, a cover sheet, or the like. It's important to note that this pipeline is being showed in different configurations, and that the data records could be job opportunities, as described above, or user profiles, as in this case. Thus, a unified pipeline or set of multiple pipelines could be utilized, depending on overall system goals. Here, the ingested job opportunities stored within the opportunity database 150 during the process 100 of FIG. 1A can be used to train a machine learning model(s) within the recommendation engine 140 to identify optimal job opportunities for a user. In this example, a user may upload or otherwise input a data record 130 with a job title, job description, and/or work history of the user. In some embodiments, the data record 130 may include a survey or questionnaire with questions specifically designed to draw out information about the user's work history.

Job descriptions that are stored within job records may contain many useful pieces of information related specifically to the job or to the employer. In addition to the processes outlined in standardization, the enrichment pipeline 120 may identify additional job detail requirements not expressly provided in the job description such as skills, work experience needed, pay rate, education needed, and the like. For example, an incoming job may be enhanced by being matched to a job profile through string matching algorithms. A job profile, which is separate from but could be related to a given user profile, as described above, is an aggregated data set that identifies the job categorization and how it fits in the standardized O*NET job hierarchy tree.

The trained machine learning model(s) within the recommendation engine 140 may be used to make predictions on incoming data records (e.g., user data records) that are matched to an optimal job opportunity or set of multiple opportunities by the machine learning model(s). In the example of FIG. 1B, the data record 130 is ingested by the host platform and may include attributes of a user such as resume details, education details, work experience details, pay rate details, skills, etc. This information may be provided by the user themselves, obtained from a website such as a resume site, and the like. The data record 130 may then be processed via the enrichment pipeline 120, which could be coupled to the recommendation engine 140 (e.g., via an input of the recommendation engine 140, via a common datastore, etc.). Here, in this embodiment of the process, the enrichment pipeline includes multiple components including a job text component 112, a skills component 114, and an earnings component 116. Each component may be used individually and not all components may necessarily be used each time. For example, only one or two of the components may be used instead of all three. Also, other components may be present.

According to various embodiments, the enrichment pipeline 120 may be implemented via a software application referred to herein as an enrichment application, and it may exist in multiple incarnations depending on the overarching system architecture needed. The enrichment application may apply a series of transformations, which can include but are not limited to standardization of job titles and employer names, processing job descriptions through a parser, including identification of education, requirements, skills, and other data, matching a user profile to a job profile, manual injection for fixing or updating data, and the like. The enrichment application may be integrated into a greater data systems architecture that is called through an application programming interface (API) and returns the newly enriched opportunities data as part of the payload. For example, the enrichment application may receive an API call with a job description of a user therein, and in response, the enrichment application may apply any of the components within the enrichment pipeline 120 to the job description to create an enriched data record, and return the enriched data record to the calling application. As another example, the enrichment application may return the optimal job opportunity or opportunities as predicted by the recommendation engine 140. In general, optimality can be configuration-driven, depending on the application.

The recommendations that are output by the recommendation engine 140 aim to identify new job opportunities based on individual preferences and help advise next steps on the path to career advancement, stabilization, change, and the like. A natural problem that arises from this process is the sheer volume of data coming in and the necessity to process that data to be relevant and up to date. Given limited resources, it is often necessary to process a limited number of data points and abstract or aggregate data up to the larger data sets. One method to achieve this is to build the ability to abstract and aggregate data within the enrichment pipeline 120. A second way is to identify a broad set of universal features (e.g., skills, etc.) that can be used to connect enriched and unenriched data sources.

In FIG. 1B, the data record 130 can be processed by each of the components within the enrichment pipeline 120. For example, the job text component 112 may parse attributes of the data record 130 such as descriptions of the user's experience, education, training, etc., into keywords and other attribute to generate an enriched data record 130a. For example, attributes such as job title, etc., may be normalized to a predefined format, standardized identifier, or the like for each job thereby enabling the host platform to abstract away any differences in naming conventions of job opportunities between employers and potential employees.

In some embodiments, the data record 130 may include information gained via responses to one or more targeted user surveys asking key questions related to current and past employment, education, work from home preference, transportation availability, location, and preferred work type areas, among others. This data can be used to directly tailor opportunities that fit to a given user's individual criteria. The user surveys may include target questions related to a user's current work needs. The key questions may cover and include current employment (e.g., job title, employer, pay rate, hours, and the like), past employment, education, work from home preference, transportation availability (e.g., car, bus, etc.), preferred work type areas, and the like. This data is used to help identify opportunities that fit their individual criteria. The enriched data record 130a generated by the job text component may additionally include attributes such as job title, employment history, responsibilities, employers, employment preferences, skills (e.g., a set of skills entered by the user, but separate from or processed later by skills component 114, discussed below), certifications, licenses, educational history, and the like.

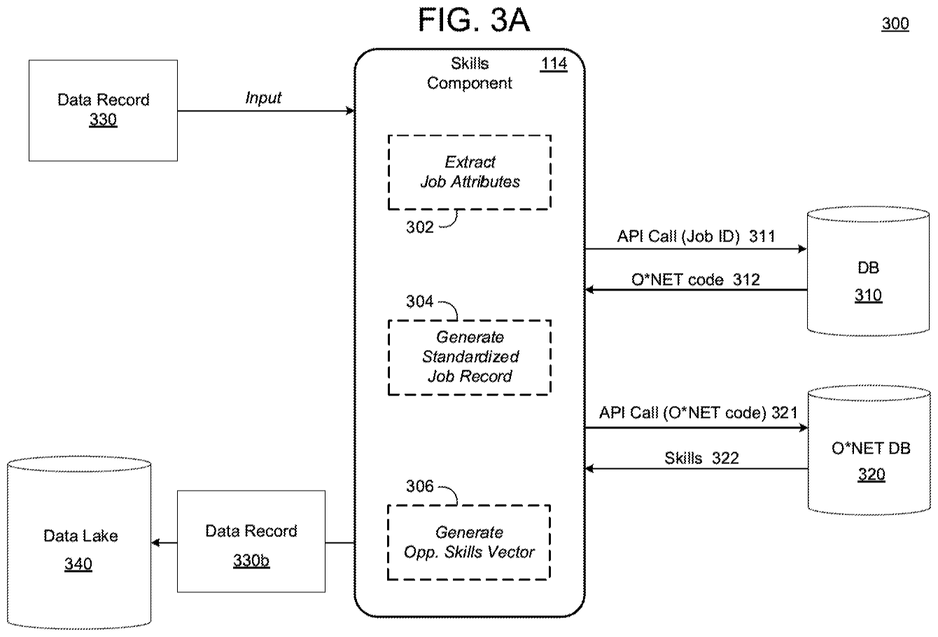

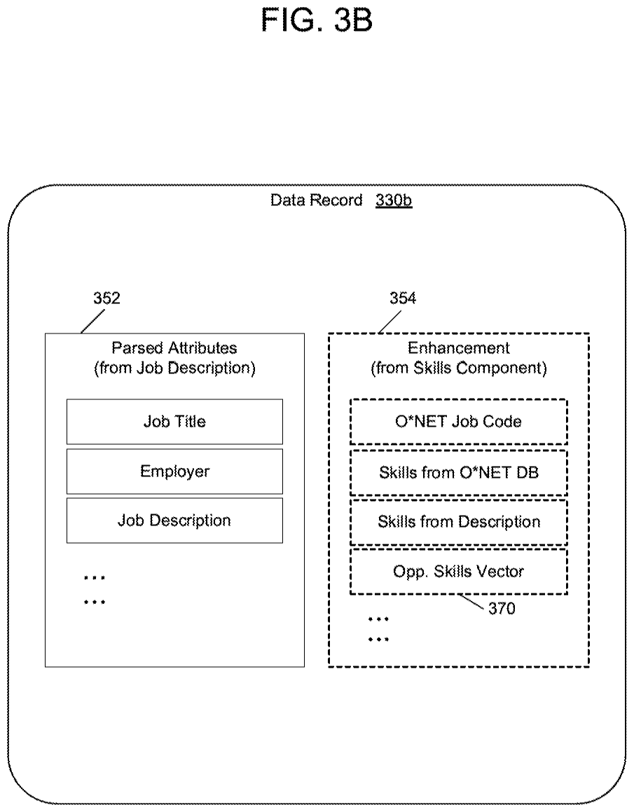

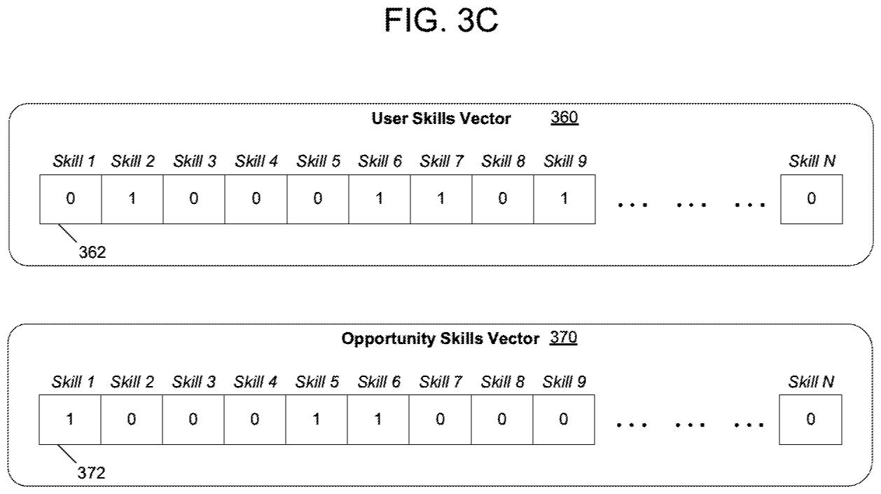

In addition, a skills component 114 within the enrichment pipeline 120 may identify skills that the user possesses by converting text descriptions within the user survey (and/or modified by the job text component 112) into a vector quantity that can be used in the construction, selection, and/or overall ranking of recommendations. This process is done by generating internal libraries of opportunity skill vectors as well as user skill vectors, which are further described later in the example of FIG. 3C, which is explained below. These skills vectors can be added to the data record 130 to create an enriched data record 130b.

With these skill vectors defined, the host platform can then build user- and job-skill graphs that can be used to connect a user to jobs using a variety of information (e.g., skills, natural career progression, common user paths, and the like) to identify and trace the user's journey through their career. Additionally, critical behavioral information from user cohorts and job-related transaction data can be learned and/or predicted using machine learning approaches to expand the many paths that can lead to increased family income and/or more satisfying job roles. With this career tree or other related embodiment in place, the recommendation engine 140 can highlight opportunities that a user is qualified for, identify opportunities that a user could be qualified for if they were to acquire additional skill sets, and create a personalized career roadmap that can allow users to attain future financial stability, success, and security.

Although not explicitly shown in FIGS. 1A and 1B, it should also be appreciated that banking transactions, payroll records, and other financial information may be ingested via the enrichment pipeline 120. For example, a user may connect their bank account and/or an employer payroll account to the host platform enabling the host platform to obtain financial and/or employment records of the user that can be processed via the earnings component 116 and used to enhance the data record 130 of the user, individually and/or in aggregate, into an enriched data record 130c. For example, the earnings component 116 may be used to identify a pay rate of the user, a period when the user was working and/or not working, dates of transactions, amounts of transactions, categories of transactions, and the like. Moreover, the pay-related information from user surveys can be compared, augmented, reconciled, or otherwise processed with the data processed or extracted by earnings component 116. All of this information can be useful for the recommendation engine 140 when predicting an optimal job opportunity for the user. For example, the earnings component 116 can identify the earnings potential of a job by utilizing the user survey and transaction data sets of other users and aggregate at known job levels. For example, if several users work at a grocery store as a sales associates, the earnings component 116 can identify or preprocess for another component or system that identifies the relevant income transactions from those users that relate to sales associate income and aggregate values of gross income across different locations. This information can then be used for ranking of recommendations.

Furthermore, the recommendation engine 140 may receive an enriched data set with any of the enriched records 130a, 130b, and 130c, as input and execute one or more machine learning models included in the recommendation engine 140 on the enriched data set to predict an optimal job opportunity for the user. A machine learning model may identify a subset of opportunities that are most closely related to the user and also rank the opportunities from an order of most likely to be of interest to less likely to be of interest, among other possible orderings. The optimal job opportunities may be displayed within a user interface (not shown) such as a mobile device of the user. The optimal job opportunity or opportunities may be displayed within a mobile application. Here, the trigger for recommending the optimal job opportunity may be in response to the user requesting such a recommendation or set of recommendations via the user interface. As another example, the host platform may periodically or randomly trigger a recommendation or set of recommendations for a user without provocation.

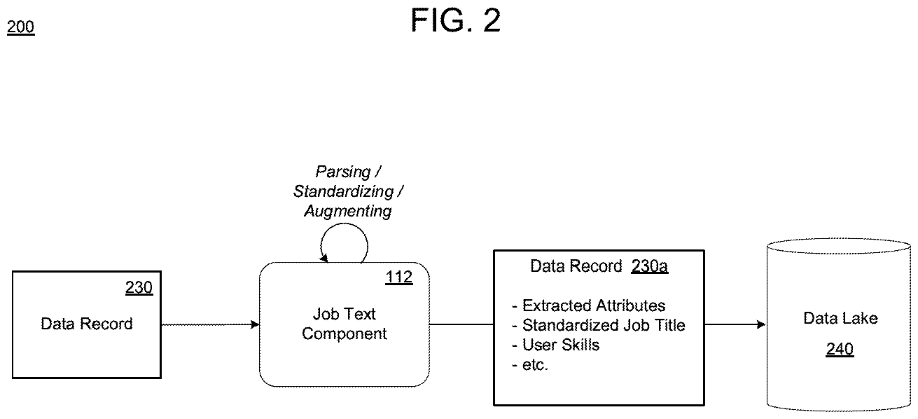

FIG. 2 illustrates a process 200 of enriching a data record 230 with job text in accordance with an example embodiment. As an example, the data record 230 may be a job opportunity uploaded by a third-party employer or a user profile component, such as a user survey or the like provided by a user. The job text component 112 may parse the data record 230 and add standardized job text including standard job titles, skills, and the like, which are identified from the data record 230. Here, the text may be normalized, cleaned, and otherwise enhanced by removing spurious terms and characters to generate a structured list of attributes within an enriched data record 230a. The enriched data record 230a may be stored in a data lake 240 of the host platform or in a separate platform.

FIGS. 3A-3C illustrate a process of enriching a user's job profile within skills, and in particular, one or more skill vectors that can be input into a machine learning model for further processing. In particular, FIG. 3A illustrates a process 300 of enriching a data record with skills data in accordance with an example embodiment. Referring to FIG. 3A, a host platform such as a web server or a cloud platform may host an enrichment application that includes a skills component 114 capable of enriching data ingested from various data sources. In this example embodiment, a user profile such as a user survey is ingested by the enrichment application from a data service such as an external data source. However, it should be appreciated that hundreds, thousands, or many more job opportunities may be ingested and/or processed on a periodic (e.g., daily, hourly, etc.) basis. Each opportunity that is ingested may be transformed into a standardized format and enriched with additional data that can be used when processing the opportunity data using machine learning algorithms. The opportunity data may include a single string value with various attributes of a web listing stored therein such as a job description, payment information, schedule data, geographic location, and the like, associated with the opportunity.

In 302, the skills component 114 extracts job attributes from the ingested data. Here, the skills component 114 may parse the string of data ingested from the data service and identify various keywords within the string corresponding to various attributes/fields of a job listing such as job title, job description, etc. The skills component 114 may then map the job title to a standard identifier such as, but not limited to, an O*NET job code. In some embodiments, the skills component 114 may query a data service of a database 310 with a job description (e.g., a block of unstructured text describing a job opportunity such as those included in a web listing, etc.) via an appropriate call made as in 311 and send this job description to the data service. In response, in 312, the data service of the database 310 may map the job description to a standard identifier, such as an O*NET job code, or the like and return this information to the enrichment application. As another example, the enrichment application may store its own mapping that can be used to translate the job description in to an O*NET job code or some other unique identifier.

Furthermore, other services may also use the same standard identifiers such as the O*NET job code to store additional data about such job titles such as the likely skills of the persons performing those job titles, and the like. These skills may be queried by the skills component. In particular, in 321, the skills component 114 may transmit an API call to a service connected to an O*NET database 320 with the standard identifier (e.g., the O*NET code) of the job opportunity included in the API call. In response, in 322, a data service of the O*NET database 320 may return additional data attributes of the employment opportunity such as skills, and the like. The skills may be standard skills that are assigned to a particular job category, as well as other classes of skills that can indicate salary enhancement, job-level differentiation, and the like. The skills component 114 may append the supplemental data to the data record 330 to generate an enriched data record 330b. In addition, in 306, the skills component 114 may also transform the skills provided by the O*NET database 320 into an opportunity vector that is added to the enriched data record 330b and that can be input into a machine learning model. The skills component 114 can also store the enriched data record 330b in a data lake 340 or other datastore of the host platform. In addition, a skills vector may also be created based on the skills provided by the user (e.g., in the user survey, etc.). Both vectors can be input to the machine learning model, among other data, parameters, and metadata. An example of the vectors are shown in FIG. 3C.

For example, a job profile such as “animal caretaker” may be assigned a particular job code (e.g., “39-2021.00”, etc.) within the O*NET database and may also include a list of predefined skills that are assigned to the job code within the O*NET database, including monitoring animals, active listening, coordination (adjusting of actions), judgement and decision making, and reading comprehension. As another example, a job profile such as waiter/waitress may include its own job code (e.g., “35-3031.00”, etc.) in the O*NET database along with predefined skills assigned thereto, including service orientation, active listening, speaking, social perceptiveness, and coordination. These again are just examples. It should be appreciated that hundreds and even thousands of job titles may be assigned their own codes in the O*NET database, and each code may be linked to respective sets of skills. The skills may overlap or at least partially overlap among some of the job codes.

FIG. 3B illustrates an example of the enriched data record 330b that is created by the skills component 114 in the process of FIG. 3B, in accordance with an example embodiment. Here, the enriched data record 330b includes extracted attributes 352 that are identified from the description of the employment opportunity. In addition, the skills component 114 can also add enhanced attributes 354 to the enriched data record 330b including a list of skills obtained from the external database such as the O*NET database, and the like. Also, an opportunity skills vector 360 can be added to the enriched data record 330b which includes a vectorized representation of the skills in a format that can be processed by a machine learning model and a computer processor (e.g., a vector, etc.).

In addition, although not shown in FIGS. 3A-3C, the skills that are added to the enriched data record 330b may be extracted from other sources such as a skills certificate or a skill-based blockchain ledger. For example, the O*NET identifier may be used to identify skills in these other resources. An example of a skills certificate is described in U.S. Provisional Patent Application No. 63/337,664, filed on May 3, 2022, in the United States Patent and Trademark Office, and an example of a skill-based blockchain ledger is described in U.S. Provisional Patent Application No. 63/348,111, filed on Jun. 2, 2022, in the United States Patent and Trademark Office, both of which are fully incorporated herein by reference for all purposes. The host system described herein may be coupled to the blockchain ledger and have the ability to both read data from the blockchain ledger (including skills) and write data to the blockchain ledger (including any enriched data).

Other skill vectors can be generated and included with the input to the machine learning model in order to predict one or more optimal job opportunities. For example, the host system may store attributes of a user including skills, job title, job description, work history, education, certifications, credentials, and the like. The host platform may generate a separate user skills vector 360 (shown in FIG. 3C) based on the attributes of the user that are stored within the host system or another third party. As another example, a user skills vector can be generated based on other users of the platform with the same job titles as the user or similar attributes. This can help to overcome skills that the user has forgotten to include.

FIG. 3C illustrates an example of the user skills vector 360 and the opportunity skills vector 370 that may be used for a machine learning process or processes in accordance with an example embodiment. Referring to FIG. 3C, the user skills vector 360 may include a plurality of cells 362 corresponding to a plurality of skills 364, respectively, where each cell corresponds to a different skill. The host platform may identify skills from the job description provided by the user and store numerical values representing the skills within the user skills vector 360. The transformation process may be performed by transforming text descriptions or other identifiers of skills into numerical values using a text-to-number converter or the like. For example, natural language processing (NLP) algorithms, topic modeling, and/or other machine learning models may be used by the process to convert a string of text into a particular numerical value. The process can even give weights to certain skills such that those skills are given more weight or less weight than the other skills by the machine learning model or other analytical process.

Likewise, the opportunity skills vector 370 may include a plurality of cells 372 corresponding to a plurality of skills that are identified from the O*NET database, respectively. It may be the same skills as in the user skills vector 360 or different skills, with various degrees of overlap in some cases. The skills embedded within the opportunity skills vector 370 may include the skills that are mapped to the O*NET job code at the O*NET database. These skills may provide the machine learning model with additional insight into the user that the user did not provide on their own, but was rather enriched by the enrichment pipeline. Accordingly, a more accurate prediction can be made.

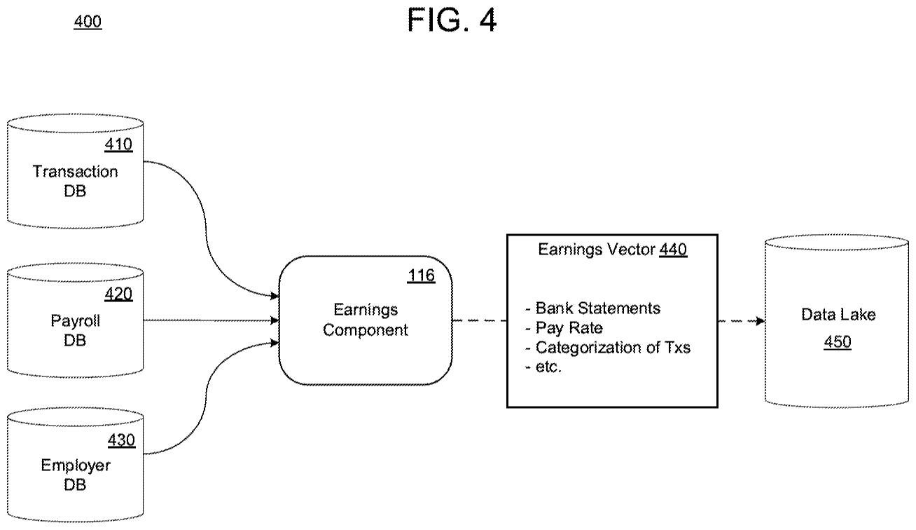

FIG. 4 illustrates a process 400 of enriching a data record with earnings data in accordance with an example embodiment. For example, the data record may be the data record 130 received in FIG. 1A. Referring to FIG. 4, an earnings component 116 of the enrichment pipeline may authenticate itself with a bank server, a payroll server, and/or the like, associated with a user and/or an employer of the user. The earnings component 116 may be provided with valid access credentials to read data from a bank statement or other account information of the user which is stored at the respective server and made available, for example, via an API of the respective server.

In the example of FIG. 4, the earnings component 116 connects to one or more of a transaction database 410, a payroll database 420, an employer database 430 such as a human resources department, and the like. In this example, the earnings components 116 may query one or more of the transaction database 410, the payroll database 420, and the employer database 430 for additional financial data associated with the user such as bank statements, transaction data, pay stubs, etc., and can process this data to identify a pay rate of a user (estimated), how the user spends their money (e.g., what categories), where the user spends their money, and the like. This information can also be considered by the machine learning model when determining an optimal job opportunity. Furthermore, the earnings component 116 may generate a vector 440 with the earnings data encoded therein which can be input to the machine learning model of the recommendation engine. The earnings vector 440 may be stored in a data lake 450. It should be appreciated that the earnings component 116 could call a separate process or service that collects and/or aggregates this data.

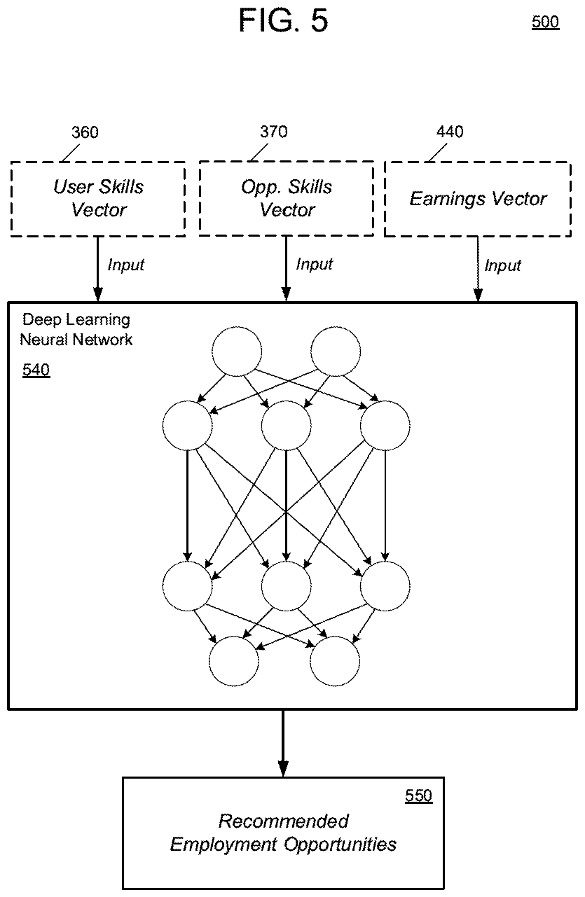

FIG. 5 illustrates a process 500 of a machine learning model 540 predicting an optimal job opportunity in accordance with an example embodiment. Referring to FIG. 5, the enriched data generated by the enrichment pipeline according to various embodiments may be input into the machine learning model 540, such as a deep learning neural network, recommendation system, or the like, which can identify an optimal job opportunity from the input data. For example, the host platform may include a script or other program which inputs the vectors generated by the host platform during the enrichment process, including any of the user skills vector 360, the opportunity skills vector 370, the earnings vector 440, and any other data and/or vectors, into the machine learning model 540. It is not necessary for all vectors to be input for the model to work accurately. Rather only one of the vectors or two of the vectors may be input and the model can provide an accurate answer. Also, other data structures that differ from vectors may be employed, depending on the embodiment.

The machine learning model 540 may be trained to identify an optimal job opportunity 550 (or multiple optimal job opportunities) based on historical job opportunity/employee pairings that have been determined to be successful (e.g., over 2 years of employment, etc.). The one or more recommended optimal job opportunities may be displayed via a user interface such as a front-end of a mobile application. The displayed information may be provided in the form of an in-app notification on a user's mobile device or it may be provided in the form of a text message, an electronic message (e-mail), or the like.

In some embodiments, the machine learning model 540 may continue to be trained to perform reinforcement learning based on its own predictions and the decisions made by the user when they receive the predicted optimal job opportunity. For example, if a user ends up applying for the predicted optimal job opportunity, the machine learning model 540 may be updated to improve the weight of such a mapping.

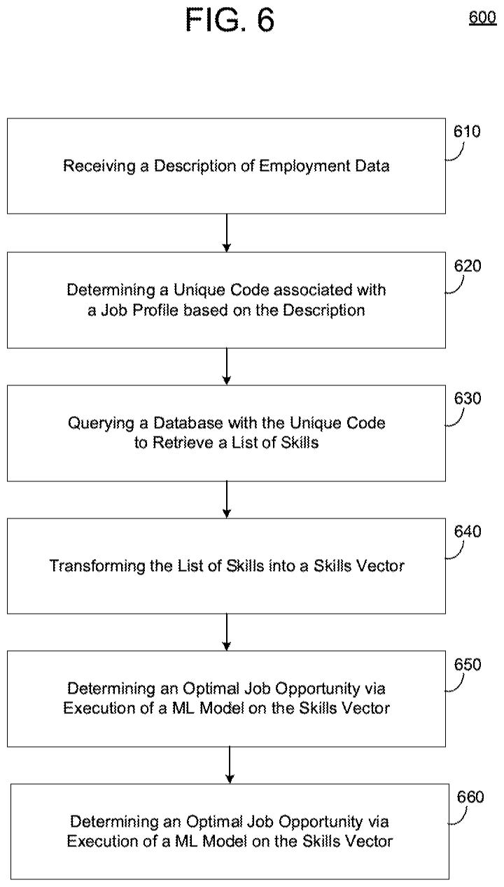

FIG. 6 is a diagram illustrating a method 600 of enriching a data record and predicting an optimal opportunity for a user based on the enriched data record according to example embodiments. Referring to FIG. 6, in 610, the method may include receiving a description of employment data of a user. In 620, the method may include determining a unique code associated with a job profile based on the description of the employment data of the user. In 630, the method may include querying a database with the unique code to retrieve a list of skills from the database and that are mapped to the unique code at the database. In 640, the method may include transforming the list of skills from the database associated with the job profile into a skills vector. In 650, the method may include determining an optimal job opportunity for the user via execution of a machine learning model on the skills vector, which is input thereto. In 660, the method may include outputting information about the determined optimal job opportunity via a user interface of a software application.

In some embodiments, the receiving comprises receiving a questionnaire with the description of the employment data and the identifying comprises identifying an Occupational Information Network (O*NET) job code corresponding to the description based on a string comparison between the description and a job title of the O*NET job code. In this example, the querying may include querying an application programming interface (API) of the database via an API call with the O*NET job code therein to retrieve the list of skills. In some embodiments, the determining the optimal job opportunity may further include inputting job-related payment data of the user pulled from a payroll system or financial institution into the machine learning model and predicting the optimal job opportunity based on a combination of the skills vector and the bank account data.

In some embodiments, the transforming may include transforming textual descriptions of a plurality of skills into a plurality of numerical values, respectively, and storing the plurality of numerical values within the vector. In some embodiments, the transforming may include transforming a plurality of descriptions of a plurality of job profiles of the user into a plurality of vectors, respectively, aggregating values within the plurality of vectors to generate an aggregated vector, and executing the machine learning model on the aggregated vector to determine the optimal job opportunity. In some embodiments, the determining the optimal job opportunity may further include assigning a greater weight to some but not all of the skills within the list of skills, and executing the machine learning model based on the assigned greater weight.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

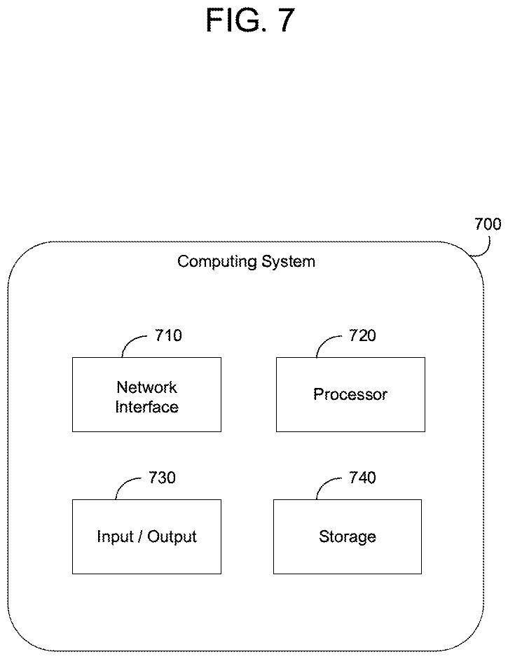

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 7 illustrates an example computing system 700 which may process or be integrated in any of the above-described examples, etc. FIG. 7 is not intended to suggest any limitation as to the scope of use or functionality of embodiments described herein. The computing system 700 is capable of being implemented and/or performing any of the functionality set forth hereinabove.

The computing system 700 may include a computer system/server, which is operational with numerous other general purpose or special purpose computing system environments or configurations. Examples of well-known computing systems, environments, and/or configurations that may be suitable for use as computing system 700 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like. According to various embodiments described herein, the computing system 700 may be a tokenization platform, server, CPU, or the like.

The computing system 700 may be described in the general context of computer system-executable instructions, such as program modules, being executed by a computer system. Generally, program modules may include routines, programs, objects, components, logic, data structures, and so on that perform particular tasks or implement particular abstract data types. The computing system 700 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 7, the computing system 700 is shown in the form of a general-purpose computing device. The components of computing system 700 may include, but are not limited to, a network interface 710, one or more processors or processing units 720, an output 730 which may include a port, an interface, etc., or other hardware, for outputting a data signal to another device such as a display, a printer, etc., and a storage device 740 which may include a system memory, or the like. Although not shown, the computing system 700 may also include a system bus that couples various system components including system memory to the processor 720.

The storage 740 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random access memory (RAM) and/or cache memory. As another example, storage device 740 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, storage device 740 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 700 may also communicate with one or more external devices such as a keyboard, a pointing device, a display, etc.; one or more devices that enable a user to interact with computer system/server; and/or any devices (e.g., network card, modem, etc.) that enable computing system 700 to communicate with one or more other computing devices. Such communication can occur via I/O interfaces. Still yet, computing system 700 can communicate with one or more networks such as a local area network (LAN), a general wide area network (WAN), and/or a public network (e.g., the Internet) via network interface 710. As depicted, network interface 710 may also include a network adapter that communicates with the other components of computing system 700 via a bus. Although not shown, other hardware and/or software components could be used in conjunction with the computing system 700. Examples include, but are not limited to: microcode, device drivers, redundant processing units, external disk drive arrays, RAID systems, tape drives, and data archival storage systems, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage device configured to store a description of employment data of a user; and
a processor configured to
determine a unique code associated with a job profile based on the description of the employment data of the user;
query a database with the unique code to retrieve a list of skills from the database which are mapped to the unique code at the database;
transform the list of skills from the database associated with the job profile into a skills vector;
determine one or more optimal job opportunities for the user via execution of a machine learning model on the skills vector which is input thereto; and
output information about the determined one or more optimal job opportunities via a user interface of a software application.

2. The computing system of claim 1, wherein the processor is configured to receive a questionnaire with the description of the employment data and identify an Occupational Information Network (O*NET) job code corresponding to the description based on a string comparison between the description and a job title of the O*NET job code.

3. The computing system of claim 2, wherein the processor is configured to query an application programming interface (API) of the database via an API call with the O*NET job code therein to retrieve the list of skills.

4. The computing system of claim 1, wherein the processor is configured to input payment data of the user pulled from a payroll system or financial institution into the machine learning model and predict the optimal job opportunity based on a combination of the skills vector and the payment data.

5. The computing system of claim 1, wherein the processor is configured to transform textual descriptions of a plurality of skills into a plurality of numerical values, respectively, and store the plurality of numerical values within the vector.

6. The computing system of claim 1, wherein the processor is configured to transform a plurality of descriptions of a plurality of job profiles of the user into a plurality of vectors, respectively, aggregate values within the plurality of vectors to generate an aggregated vector, and execute the machine learning model on the aggregated vector to determine the optimal job opportunity.

7. The computing system of claim 1, wherein the processor is configured to assign a greater weight to some but not all of the skills within the list of skills, and execute the machine learning model based on the assigned greater weight.

8. A method comprising:
receiving a description of employment data of a user;
determining a unique code associated with a job profile based on the description of the employment data of the user;
querying a database with the unique code to retrieve a list of skills from the database and that are mapped to the unique code at the database;
transforming the list of skills from the database associated with the job profile into a skills vector;
determining one or more optimal job opportunities for the user via execution of a machine learning model on the skills vector which is input thereto; and
outputting information about the determined one or more optimal job opportunities via a user interface of a software application.

9. The method of claim 8, wherein the receiving comprises receiving a questionnaire with the description of the employment data and the identifying comprises identifying an Occupational Information Network (O*NET) job code corresponding to the description based on a string comparison between the description and a job title of the O*NET job code.

10. The method of claim 9, wherein the querying comprises querying an application programming interface (API) of the database via an API call with the O*NET job code therein to retrieve the list of skills.

11. The method of claim 8, wherein the determining the optimal job opportunity further comprises inputting payment data of the user pulled from a payroll system or financial institution into the machine learning model and predicting the optimal job opportunity based on a combination of the skills vector and the payment data.

12. The method of claim 8, wherein the transforming comprises transforming textual descriptions of a plurality of skills into a plurality of numerical values, respectively, and storing the plurality of numerical values within the vector.

13. The method of claim 8, wherein the transforming comprises transforming a plurality of descriptions of a plurality of job profiles of the user into a plurality of vectors, respectively, aggregating values within the plurality of vectors to generate an aggregated vector, and executing the machine learning model on the aggregated vector to determine the optimal job opportunity.

14. The method of claim 8, wherein the determining the optimal job opportunity further comprises assigning a greater weight to some but not all of the skills within the list of skills, and executing the machine learning model based on the assigned greater weight.

15. A non-transitory computer-readable medium comprising instructions which when executed by a processor cause a computer to perform a method comprising:
receiving a description of employment data of a user;
determining a unique code associated with a job profile based on the description of the employment data of the user;
querying a database with the unique code to retrieve a list of skills from the database and that are mapped to the unique code at the database;
transforming the list of skills from the database associated with the job profile into a skills vector;
determining one or more optimal job opportunities for the user via execution of a machine learning model on the skills vector which is input thereto; and
outputting information about the determined one or more optimal job opportunities via a user interface of a software application.

16. The non-transitory computer-readable medium of claim 15, wherein the receiving comprises receiving a questionnaire with the description of the employment data and the identifying comprises identifying an Occupational Information Network (O*NET) job code corresponding to the description based on a string comparison between the description and a job title of the O*NET job code.

17. The non-transitory computer-readable medium of claim 16, wherein the querying comprises querying an application programming interface (API) of the database via an API call with the O*NET job code therein to retrieve the list of skills.

18. The non-transitory computer-readable medium of claim 15, wherein the determining the optimal job opportunity further comprises inputting payment data of the user pulled from a payroll system or financial institution into the machine learning model and predicting the optimal job opportunity based on a combination of the skills vector and the payment data.

19. The non-transitory computer-readable medium of claim 15, wherein the transforming comprises transforming textual descriptions of a plurality of skills into a plurality of numerical values, respectively, and storing the plurality of numerical values within the vector.

20. The non-transitory computer-readable medium of claim 15, wherein the determining the optimal job opportunity further comprises assigning a greater weight to some but not all of the skills within the list of skills, and executing the machine learning model based on the assigned greater weight.
